(19) United States
(12) Patent Application Publication
(10) Pub. No.: US 2017/0347844 A1
(43) Pub. Date: Dec. 7, 2017

(54) BUTTOCK WIPING DEVICE

(71) Applicant: OKADA MANUF. CO., LTD., Osaka (JP)

(72) Inventor: Shoji OKADA, Osaka (JP)

(21) Appl. No.: 15/612,400

(22) Filed: Jun. 2, 2017

(30) Foreign Application Priority Data
Jun. 7, 2016 (JP) 2016-113698
Apr. 24, 2017 (JP) 2017-085475

(51) Int. Cl. A47K 7/08; A47K 7/04; B05B 1/24; E03D 9/08

(52) U.S. Cl. CPC A47K 7/08; E03D 9/08; A47K 7/04; B05B 1/24

(57) ABSTRACT

A buttock wiping device includes a wiping arm including a head portion configured to press a wiping material against the buttocks, a wiping arm drive unit configured to move the wiping arm, and a control unit configured to control operation of the wiping arm drive unit. The control unit controls a movement path of the wiping arm such that the head portion moves along the path of water sprayed from a cleansing nozzle of a warm-water cleansing device in cleansing of a private area. Alternatively, a private area position is estimated, and the control unit controls the movement path of the wiping arm such that the head portion reaches the estimated position. As another alternative, the control unit controls the movement path of the wiping arm such that the head portion reaches the private area position.

### CROSS-REFERENCE TO RELATED APPLICATION

This application claims priority from Japanese Patent Application Nos. 2016-113698 filed on Jun. 7, 2016, and 2017-085475 filed on Apr. 24, 2017, with the Japan Patent Office, the entire contents of which are hereby incorporated by reference.

### BACKGROUND

### 1. Technical Field

The present disclosure relates to a d for wiping the buttocks with paper, and more specifically relates to a buttock wiping device configured so that the buttocks can be accurately wiped.

### 2. Description of the Related Art

Typically, devices described in JP-A-2009-061126, JP-A-2009-263859, JP-A-2011-062532, JP-A-2011-143233, JP-A-2011-144623, JP-A-2011-200627, JP-A-2012-172486, JP-A-2014-064885, JP-A-2014-094261, JP-A-2014-113508, JP-A-2014-131775, JP-A-2014-132155, JP-A-2014-207949, JP-A-2014-233309, JP-A-2015-006603, JP-A-2015-062712, JP-A-2015-062825, JP-A-2015-104617, JP-A-2015-192893, JP-A-2016-028750, JP-A-2016-028751, JP-A-2016-034565, JP-A-2016-040013, JP-A-2016-041894, Chinese Utility Model Publication No. 2682113, Chinese Patent Application Publication No. 101368403, WO 2005/087067 A, German Patent No. 251031, WO 2016/152881 A, JP-A-2016-104222, JP-A-2016-179002, JP-A-2016-179003, JP-A-2016-214924, JP-A-2016-202588, JP-A-2016-221116, JP-A-2017-006619, JP-A-2017-006622, JP-A-2017-008679, JP-A-2017-008701, JP-A-2017-006616, and JP-A-2017-006617 have been known as devices for mechanically wiping, e.g., moisture or dirt on the buttocks. Each device described in JP-A-2009-061126, JP-A-2009-263859, JP-A-2011-062532, JP-A-2011-143233, JP-A-2011-144623, JP-A-2011-200627, JP-A-2012-172486, JP-A-2014-064885, JP-A-2014-094261, JP-A-2014-113508, JP-A-2014-131775, JP-A-2014-132155, JP-A-2014-207949, JP-A-2014-233309, JP-A-2015-006603, JP-A-2015-062712, JP-A-2015-062825, JP-A-2015-104617, JP-A-2015-192893, JP-A-2016-028750, JP-A-2016-028751, JP-A-2016-034565, JP-A-2016-040013, and JP-A-2016-041894 includes a wiping arm for attachment of toilet paper, and a wiping arm drive unit configured to drive the wiping arm. These devices are each configured so that moisture etc. on the buttocks can be wiped in a state in which a head portion of the wiping arm to which the toilet paper is attached is pressed against the buttocks. The devices as described in WO 2016/152881 A, JP-A-2017-006616, and JP-A-2017-006617 are each disclosed as a device for wiping the buttocks in such a manner that a wiping material supplied from a paper placement guide is lifted from below by a head portion. These documents disclose the devices configured not to hold the wiping material by the head. Moreover, WO 2016/152881 A also discloses the device configured to move, without holding the wiping material, the wiping material with the wiping material being placed on the head portion.

In the typical buttock wiping device, the following control is made: the wiping arm moves in a predetermined path such that the head portion reaches the vicinity of the anus, and the head portion to which the toilet paper is attached contacts the vicinity of the anus. Moreover, the wiping arm is moved up and down, back and forth, and right to left such that moisture etc. in the vicinity of the anus is wiped across a wide area. Note that in the typical buttock wiping device, a user can control movement of the wiping arm according to a user's preference.

### SUMMARY

For development of the buttock wiping device, the inventor(s) of the present application has conducted study with many people on a relative position relationship between the anus and a toilet seat. As the study on the anus position progresses, it has been found that there is a great variation due to an individual difference in the anus position.

In the typical buttock wiping device, the anus position is assumed to a certain degree, and the wiping arm is controlled such that the head portion moves to the assumed anus position. However, because of the variation due to the individual difference in the anus position, there is a case where moisture etc. cannot be properly wiped even when the head portion is moved to the assumed anus position. Needless to say, when the head portion is, for example, moved back and forth, up and down, and right to left to perform wiping across the wide area, wiping can be performed regardless of the variation due to the individual difference. However, the feeling of wiping is more improved when wiping is performed in a state in which the head portion contacts, from the beginning, a wiping position requested by the user.

Needless to say, the user can operate the buttock wiping device to adjust the position of the head. However, it is not easy for people with hand impairment and people not skillful at machine operation to adjust the position of the head.

For these reasons, the present disclosure is intended to provide a buttock wiping device configured so that wiping can be performed according to an individual difference in an anus position.

For solving the above-described problems, the present disclosure has the following features. The present disclosure relates to a buttock wiping device including a wiping arm including a head portion, a wiping arm drive unit configured to move the wiping arm, and a control unit configured to control operation of the wiping arm drive unit. The control unit controls a movement path of the wiping arm such that the head portion moves to an estimated private area position.

The present disclosure relates to a buttock wiping device including a wiping arm including a head portion, a wiping arm drive unit configured to move the wiping arm, and a control unit configured to control operation of the wiping arm drive unit. The control unit controls a movement path of the wiping arm such that the head portion moves along the path of water sprayed from a cleansing nozzle of a warm-water cleansing device in cleansing of a private area.

The buttock wiping device may further include, as one embodiment, a nozzle position detection unit configured to detect the position of the cleansing nozzle in cleansing of the private area. The control unit may control the movement path of the wiping arm such that the head portion moves along the water path based on the position of the cleansing nozzle detected by the nozzle position detection unit.

Moreover, a private area position may be estimated, and the control unit may control the movement path of the wiping arm such that the head portion reaches the estimated position.

The buttock wiping device may further includes, as one embodiment, a private area position estimation unit configured to estimate the private area position. The control unit may control the movement path of the wiping arm such that the head portion reaches the position estimated by the private area position estimation unit.

Moreover, the buttock wiping device may include a private area position detection unit configured to detect the private area position. The control unit may control the movement path of the wiping arm such that the head portion reaches the private area position detected by the private area position detection unit.

According to one embodiment of the present disclosure, the movement path of the wiping arm is controlled such that the head portion moves to the estimated private area position, and therefore, the head portion can reliably wipe the vicinity of the anus according to an individual difference in an anus position.

According to one embodiment of the present disclosure, the control unit controls the movement path of the wiping arm such that the head portion moves along the path of water sprayed from the cleansing nozzle of the warm-water cleansing device in cleansing of the anus. Thus, the anus is positioned at the end of the sprayed water, and therefore, the head portion can come into contact with the vicinity of the anus. Consequently, reliable wiping is realized.

Moreover, the length of an exposed portion of the nozzle is merely detected by the nozzle position detection unit, and therefore, the structure of a sensor etc. for detection can be simplified.

Further, according to one embodiment of the present disclosure, the anus position is estimated, and the control unit controls the movement path of the wiping arm such that the head position reaches the estimated position. With this structure, the anus position can be estimated according to the individual difference for movement of the head portion, and therefore, more reliable wiping is realized as compared to a typical method in which a head portion moves to an anus position assumed in a single uniform way. In addition, control is merely made such that the head portion is lifted from below the estimated position, and therefore, control of the wiping arm drive unit is facilitated.

Moreover, the length of the exposed portion of the nozzle is merely detected by the anus position estimation unit, and therefore, the structure of the sensor etc. for detection can be simplified.

Further, according to one embodiment of the present disclosure, the anus position is detected, and the control unit controls the movement path of the wiping arm such that the head portion reaches the anus position. With this structure, the head portion can be moved to an accurate anus position, leading to reliable wiping. In addition, control is merely made such that the head portion is lifted from below the anus position, and therefore, control of the wiping arm drive unit is facilitated.

These objects, features, aspects, and advantageous effects of the present disclosure and other objects, features, aspects, and advantageous effects of the present disclosure will be, with reference to the attached drawings, further apparent from description made below.

### BRIEF DESCRIPTION OF THE DRAWINGS

FIG. 1 is a block diagram of a functional configuration of a buttock wiping device 1 of a first embodiment of the present disclosure;

FIG. 2 is a view of an outline of a mechanism example of a wiping arm drive unit 3;

FIG. 3 is a conceptual view of a toilet bowl 11 from the left side;

FIG. 4 is a view of a relationship between a cleansing nozzle 8 and a nozzle position;

FIG. 5 is a view of a movement path of a head portion 31 in wiping;

FIG. 6 is a flowchart of operation of a warm-water cleansing device 7 and the buttock wiping device 1 in the first embodiment;

FIG. 7 is a block diagram of a functional configuration of a buttock wiping device 1 of a second embodiment of the present disclosure;

FIG. 8 is a view of the method for estimating an anus position;

FIG. 9 is a view of a movement path when a head portion 31 moves toward an estimated position;

FIG. 10 is a flowchart of operation of a warm-water cleansing device 7 and the buttock wiping device 1 in the second embodiment;

FIG. 11 is a block diagram of a functional configuration of a buttock wiping device 1 of a third embodiment of the present disclosure;

FIG. 12 is a view of the method for detecting an anus position;

FIG. 13 is a view of a movement path when a head portion 31 moves toward a detected anus position;

FIG. 14 is a flowchart of operation of a warm-water cleansing device 7 and the buttock wiping device 1 in the third embodiment;

FIG. 15A is a block diagram of a functional configuration of a buttock wiping device 1 in the case of using a paper placement guide 100; and

FIG. 15B is a view of an outline of a mechanism example of the buttock wiping device 1 illustrated in FIG. 15A.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### First Embodiment

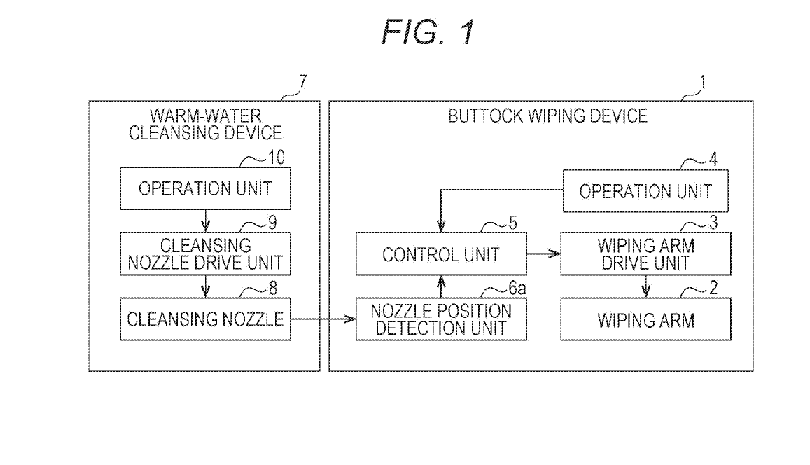

FIG. 1 is a block diagram of a functional configuration of a buttock wiping device 1 of a first embodiment of the present disclosure. Note that in addition to the buttock wiping device 1, FIG. 1 also illustrates a block diagram of a functional configuration of a warm-water cleansing device 7.

In FIG. 1, the buttock wiping device 1 includes a wiping arm 2, a wiping arm drive unit 3, an operation unit 4, a control unit 5, and a nozzle position detection unit 6a. The warm-water cleansing device 7 includes a cleansing nozzle 8, a cleansing nozzle drive unit 9, and an operation unit 10. The warm-water cleansing device 7 is configured to drive and move, according to operation of the operation unit 10 by a user, the cleansing nozzle 8 back and forth by the cleansing nozzle drive unit 9, thereby causing the cleansing nozzle 8 to spray water. In this manner, the anus is cleansed. The buttock wiping device 1 is configured to drive, according to operation of the operation unit 4 by the user, the wiping arm drive unit 3 by the control unit 5, thereby moving the wiping arm 2. A wiping material such as toilet paper is automatically or manually attached or placed onto the wiping arm. After cleansing of the anus by the warm-water cleansing device 7, the buttock wiping device 1 presses the wiping material attached or placed onto the wiping arm 2 against the vicinity of the anus, thereby wiping moisture or dirt on the buttocks.

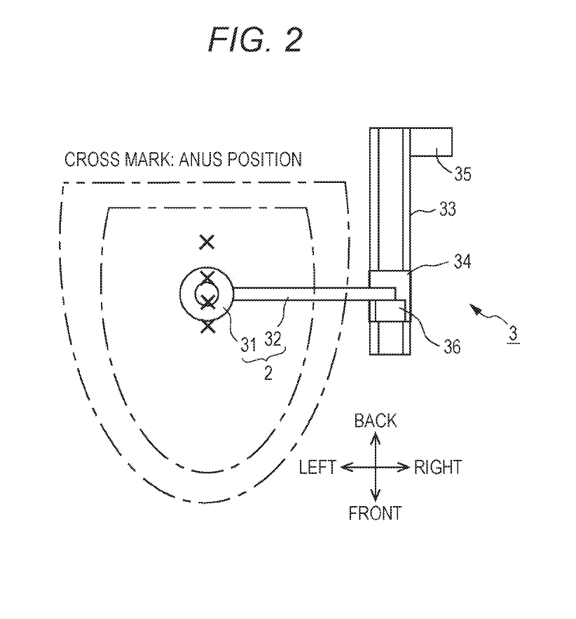

Various structures of the wiping arm drive unit 3 are conceivable, and are not intended to specifically limit the present disclosure. For example, for moving the wiping arm 2 with respect to three axes of front-to-back, upper-to-lower, and right-to-left axes, three or more motors may be used. FIG. 2 is a view of an outline of a mechanism example of the wiping arm drive unit 3. Note that the mechanism example illustrated in FIG. 2 is set forth merely as an example, and is not intended to limit the present disclosure. Any mechanisms may be employed as the wiping arm drive unit 3 as long as the wiping arm is movable to a buttock wiping position.

In the example illustrated in FIG. 2, the wiping aim drive unit 3 includes a front-to-back drive rail 33, a right-to-left rotation motor 34, a front-to-back drive motor 35, and an upper-to-lower motor 36. The right-to-left rotation motor 34 is attached to a sliding table of the front-to-back drive rail 33. The front-to-back drive motor 35 is attached to the front-to-back drive rail 33. By rotation of the front-to-back drive motor 35, an object placed on the sliding table of the front-to-back drive rail 33 can be moved back and forth. The upper-to-lower motor 36 is attached onto the right-to-left rotation motor 34. By rotation of a rotary shaft of the right-to-left rotation motor 34, the wiping arm 2 attached to the upper-to-lower motor 36 moves from the right to the left, and as a result, is exposed from a retracted position to a toilet bowl side. A base portion of the wiping arm 2 including a head portion 31 and an arm portion 32 is attached to a rotary shaft of the upper-to-lower motor 36. By swingable rotation of the upper-to-lower motor 36, the wiping arm 2 can be moved up and down. In wiping, the wiping arm 2 is moved upward by the upper-to-lower motor 36 such that the head portion 31 onto which the wiping material is attached or placed contacts the vicinity of the anus. In paper discharging, the wiping arm 2 is moved downward by the upper-to-lower motor 36 so that the wiping material can be dropped. After completion of wiping, the right-to-left rotation motor 34 rotates to move the wiping arm 2 from an exposed position to the retracted position, i.e., from the left to the right. Then, the wiping arm 2 returns to an original position by rotation of the front-to-back drive motor 35.

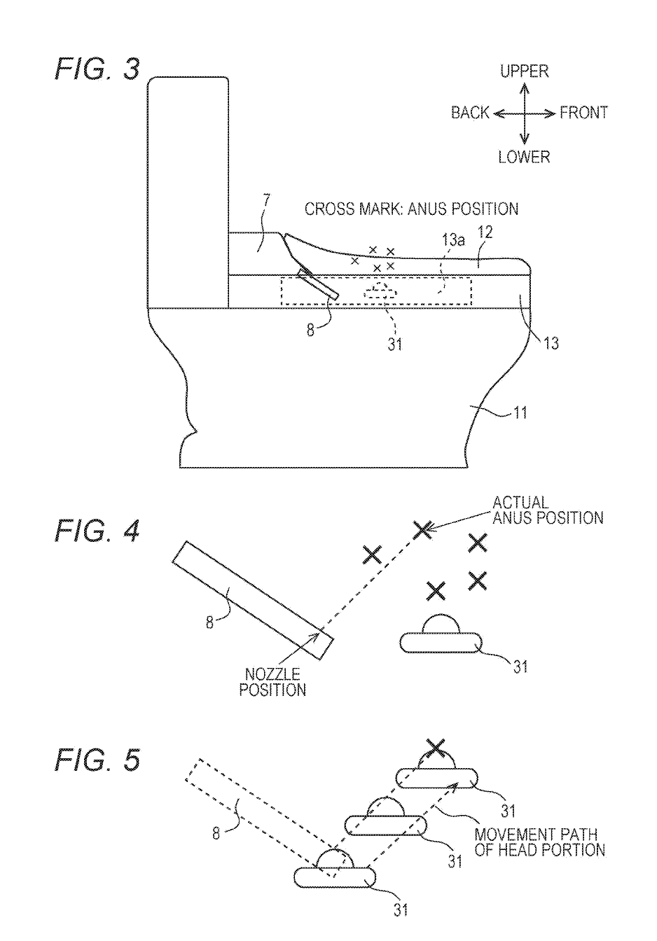

FIG. 3 is a conceptual view of a toilet bowl 11 from the left side. A raised portion 13 is provided between a toilet seat 12 and the toilet bowl 11. The raised portion 13 is provided with a clearance 13a, and the wiping arm 2 is exposed on the toilet bowl side through the clearance 13a. Note that the raised portion 13 is not necessarily provided. The thickness of the toilet seat 12 may be increased such that the clearance 13a is provided at the toilet seat 12, and in this manner, the wiping arm 2 may be exposed on the toilet bowl side through the clearance 13a. Alternatively, the toilet seat 12 or the warm-water cleansing device 7 may be slightly raised such that the wiping arm 2 is exposed through a clearance formed between the toilet bowl 11 and the toilet seat 12 by such raising.

That is, the present disclosure is not limited to the case of using the raised portion. Thus, the present disclosure is also usable for, e.g., a structure in which a toilet seat lifting/lowering device is used to form a clearance between the toilet bowl and the toilet seat such that the wiping arm is exposed on the toilet bowl side through such a clearance. Moreover, the present disclosure is also usable for, e.g., a structure in which a hole is formed at the toilet bowl such that the wiping arm is exposed on the toilet bowl side through such a hole.

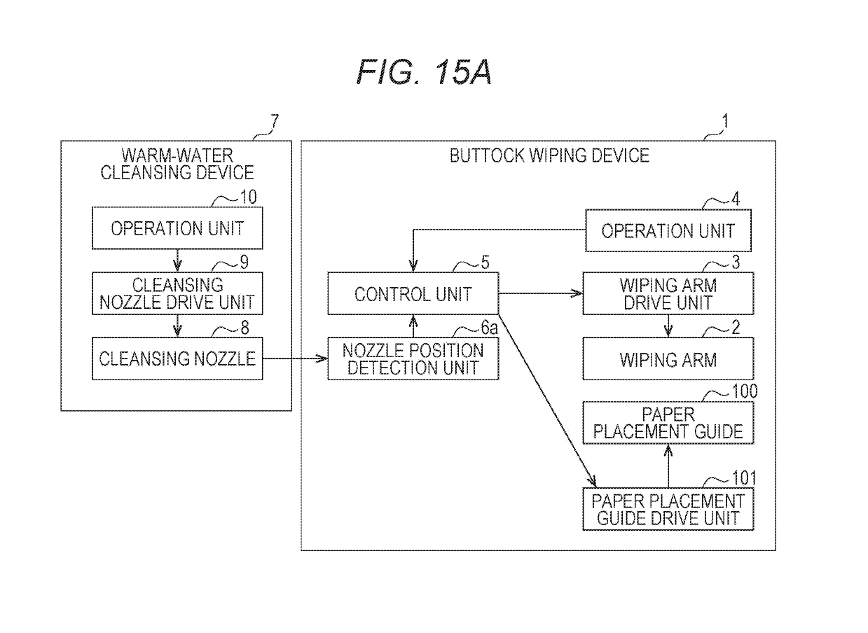

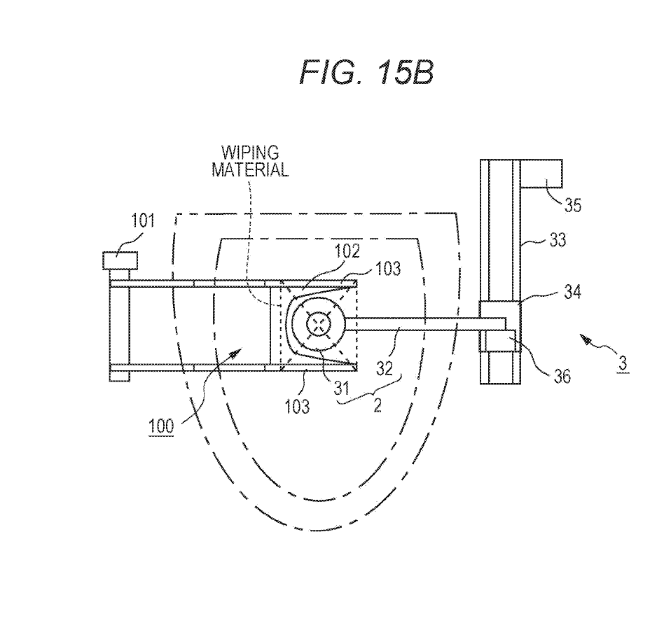

Variations of the buttock wiping device include a structure illustrated in FIGS. 15A and 15B as described in WO 2016/152881 A, JP-A-2017-006616, and JP-A-2017-006617. FIG. 15A is a block diagram of the functional configuration of the buttock wiping device 1 in the case of using a paper placement guide 100. FIG. 15B is a view of an outline of a mechanism example of the buttock wiping device 1 illustrated in FIG. 15A.

As illustrated in FIGS. 15A and 15B, the buttock wiping device 1 includes a paper placement guide drive unit 101 and the paper placement guide 100. The paper placement guide 100 includes a paper placement table 102 and extendable rails 103. The paper placement guide 100 is provided separately from the wiping arm drive unit 3, and the paper placement table 102 is provided with the paper placement table 102 being sandwiched between the extendable rails 103. The extendable rails 103 are multistage rails, and each have such a structure that the extendable rail 103 extends/contracts in association with rotation of the drive motor 101. For example, lower portions of the extendable rails 103 are placed as racks, and a pinion is attached to a rotary shaft of the drive motor 101. With this rack-and-pinion structure, the extendable rails 103 extend/contract in association with rotation of the drive motor 101.

The wiping material is manually or automatically placed on the paper placement table 102. The paper placement guide 100 is exposed on the toilet bowl side through, e.g., a hole provided at the raised portion 13 or the clearance formed between the toilet bowl and the toilet seat by the toilet seat lifting/lowering device. The paper placement table 102 is hollowed out to such a size that the head portion 31 passes through the paper placement table 102. After the paper placement guide 100 has exposed the wiping material below the anus, the head portion 31 lifts from below the wiping material, and presses the wiping material against the buttocks. With this structure, wiping is performed.

The present disclosure is also usable in the buttock wiping device having the structure illustrated in FIGS. 15A and 15B. Note that the buttock wiping device illustrated in FIGS. 15A and 15B is specifically disclosed in WO 2016/152881 A, JP-A-2017-006616, and JP-A-2017-006617.

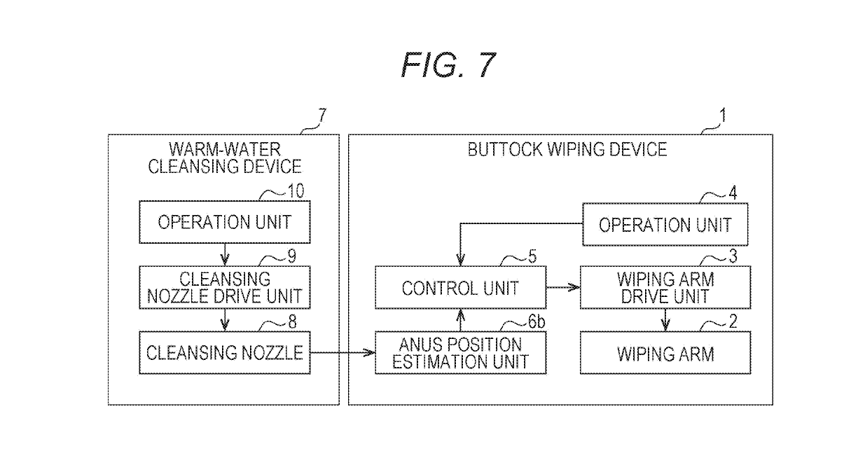

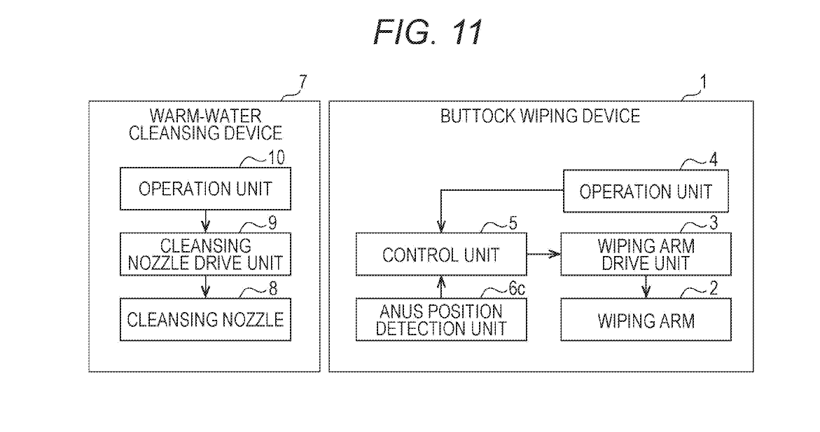

Note that a nozzle position detection unit in FIGS. 15A and 15B may be, needless to say, replaced with a later-described anus position estimation unit 6b of FIG. 7, or may be replaced with a later-described anus position detection unit 6c of FIG. 11.

Note that the structure of the buttock wiping device used in the present disclosure is not specifically limited, and the present disclosure is also usable for other buttock wiping devices than the structures illustrated in FIGS. 1, 2, 15A, and 15B.

Regarding the buttock wiping device 1 having the above-described basic structure, features of the present disclosure will be described below.

In the first embodiment, the buttock wiping device 1 includes the nozzle position detection unit 6a. The nozzle position detection unit 6a is a sensor configured to detect the degree of extension of the cleansing nozzle 8. The nozzle position detection unit 6a detects a nozzle position in cleansing of the anus.

For example, a potentiometer is used as the nozzle position detection unit 6a, thereby detecting the degree of extension of the cleansing nozzle 8. Note that a sensor or a detection section used as the nozzle position detection unit 6a is not specifically limited.

FIG. 4 is a view of a relationship between the cleansing nozzle 8 and the nozzle position. The nozzle position described herein indicates a spray port through which water is sprayed as illustrated in FIG. 4, but is not limited to the spray port as long as the nozzle position is the position of a tip end portion of the nozzle. As illustrated in FIG. 4, the cleansing nozzle 8 is extended for water spraying, and therefore, water comes into contact with the actual anus position of the user. The exposure angle of the cleansing nozzle 8 is predetermined, and a water spray angle is also predetermined. Thus, when the length of the exposed portion of the cleansing nozzle 8 can be detected, the nozzle position can be obtained by calculation. The length of the exposed portion of the cleansing nozzle is detected by the nozzle position detection unit 6a. The nozzle position is obtained by calculation based on the detected length of the exposed portion, but such calculation may be performed by the nozzle position detection unit 6a or the control unit 5. That is, it can be said that in the case of calculating the nozzle position by the control unit 5, the control unit 5 functions as the nozzle position detection unit 6a in such calculation.

Note that the angle of water sprayed from the cleansing nozzle 8 is predetermined, but a sprayed water pressure can be adjusted depending on the function of the warm-water cleansing device 7. In a case where the sprayed water pressure is adjustable, there is a probability that the water spray angle changes accordingly. That is, there is a probability that a weak water flow results in a lower spray angle and the water contact position of the buttocks also changes, and vice versa. However, even when the sprayed water pressure is adjustable, the water spray angle after adjustment is predetermined according to the sprayed water pressure. Thus, even when the warm-water cleansing device 7 has the function of adjusting the sprayed water pressure, the control unit 5 can determine the water spray angle as indicated by a dashed line of FIG. 4, considering the sprayed water pressure.

In the first embodiment, a top portion of the head portion 31 is moved to the calculated nozzle position, and the control unit 5 controls the wiping arm drive unit 3 such that the head portion 31 moves along the water splash angle. In this manner, the wiping arm 2 is moved. FIG. 5 is a view of a movement path of the head portion 31 in wiping. As described above, the control unit 5 controls a movement path of the wiping arm 2 such that the head portion 31 moves along the path of water sprayed from the cleansing nozzle drive unit 9 of the warm-water cleansing device 7 in cleansing of the anus. When the head portion 31 moves along the water spray path, the head portion 31 actually comes into contact with the anus somewhere. Thus, wiping at an accurate position can be performed.

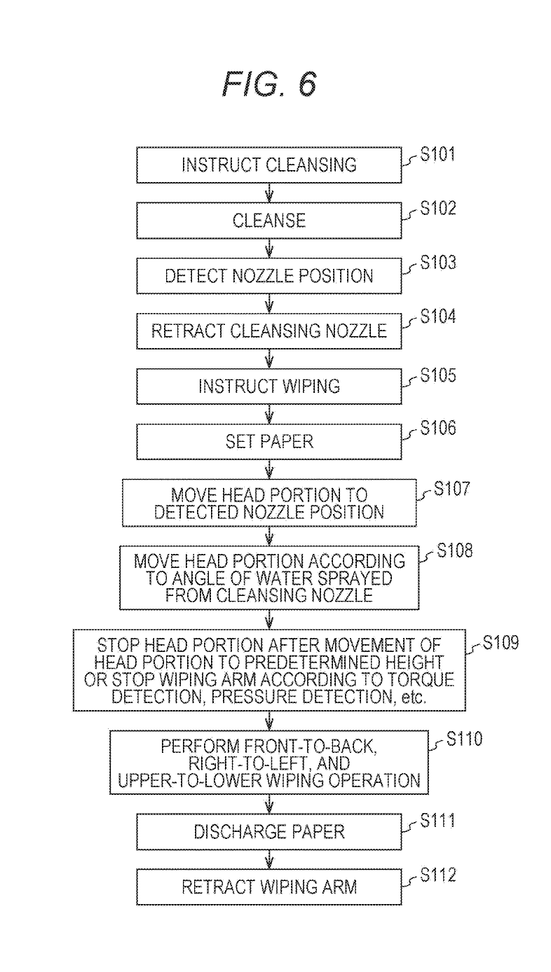

FIG. 6 is a flowchart of operation of the warm-water cleansing device 7 and the buttock wiping device 1 in the first embodiment. When the user uses the operation unit 10 to instruct cleansing (S101), the cleansing nozzle drive unit 9 drives the cleansing nozzle 8, thereby cleansing the anus (S102). In such cleansing, the nozzle position detection unit 6a detects the nozzle position (S103). This allows the control unit 5 to recognize the nozzle position. At this step, a signal indicating that cleansing is being performed is transmitted from the warm-water cleansing device 7 to the buttock wiping device 1, and the nozzle position detection unit 6a can recognize that cleansing is being performed.

When the user uses the operation unit 10 to instruct termination of cleansing, the warm-water cleansing device 7 retracts the cleansing nozzle 8 (S104). Next, when the user uses the operation unit 4 to instruct start of wiping, the buttock wiping device 1 sets paper (the wiping material) on the head portion 31 (S106). At this step, paper such as toilet paper is used as the wiping material, but any other wiping materials than paper, such as cotton or non-woven fabric, may be used as the wiping material as long as these materials are for wiping off.

The method for setting paper may include a method in which the head portion 31 is, in a case where the head portion 31 has an openable structure, closed with paper being inserted into an opening of the head portion 31 and the paper is held by the head portion 31. Alternatively, in a case where paper is merely placed on the head portion 31, the head portion 31 is made of a material exhibiting high frictional properties, and therefore, the paper can be moved to below the buttocks without dropping upon movement of the wiping arm 2. The following method can be used as the method for placing paper on the head portion 31: an automatic electric roll including a cutting unit and a paper feeding unit is placed on the head portion 31, and then, automatically-folded and -cut paper is placed on the head portion 31. Alternatively, there is a method in which thick paper is placed on the head portion 31 while being automatically cut to a predetermined length, and in this case, it is not necessary to cut the paper. In addition, paper may be manually placed on the head portion 31. Note that the above-described methods for setting paper have been set forth merely as examples, and are not intended to limit the present disclosure.

Next, the control unit 5 controls operation of the wiping arm drive unit 3 such that the head portion 31 moves to the detected nozzle position, thereby moving the wiping arm 2 (S107). When the head portion 31 reaches the nozzle position, the control unit 5 controls the wiping arm drive unit 3 such that the head portion 31 moves according to the angle of water sprayed from the cleansing nozzle, thereby moving the head portion 31 (S108). In this manner, the head portion 31 moves along the water spray path.

While the head portion 31 is moving along the water spray path, the head portion 31 comes into contact with the buttocks somewhere. When the head portion 31 contacts the buttocks, the control unit 5 needs to stop movement of the head portion 31. In the present embodiment, when the head portion 31 moves to a predetermined height, the control unit 5 controls the wiping arm drive unit 3 such that movement of the head portion 31 is stopped. Alternatively, the control unit 5 determines, by torque detection or pressure detection, that the head portion 31 contacts the buttocks, thereby controlling the wiping arm drive unit 3 to stop movement of the head portion 31 (S109).

Various methods for detecting the height of the head portion 31 are conceivable. A sensor for height detection may be provided at the wiping arm 2, or the control unit 5 may calculate the height of the head portion 31 from the rotation angle of each motor of the wiping arm drive unit 3.

For torque detection, a sensor configured to detect a torque on each motor of the wiping arm drive unit 3 may be provided, thereby allowing the control unit 5 to detect the torque on each motor. When the head portion 31 contacts the buttocks, the control unit 5 may detect an increase in the torque, and may stop movement of the head portion 31.

For pressure detection, a pressure sensor including, e.g., a strain gauge may be provided at the head portion 31. When the head portion 31 contacts the buttocks, the control unit 5 may detect, using the pressure sensor, a pressure to stop movement of the head portion 31. Alternatively, a pressure sensor such as a strain gauge may be attached to the arm portion 32. When the head portion 31 contacts the buttocks, the pressure may be detected by detection of strain of the arm portion 32. As another alternative, a pressure sensor such as a load cell may be attached to, e.g., a base portion of the arm portion 32, and the pressure may be detected according to a detection result of the load cell.

After the head portion 31 has been stopped, the control unit 5 controls the wiping arm drive unit 3, thereby performing the operation of wiping the vicinity of the anus such that the head portion 31 moves back and forth, right to left, and up and down (S110).

After wiping is performed as described above, the control unit 5 controls the wiping arm drive unit 3 to perform paper discharge operation (S111), and causes the wiping arm drive unit 3 to retract the wiping arm (S112). In this manner, a series of wiping operation ends.

As described above, in the first embodiment, the control unit 5 controls the movement path of the wiping arm 2 such that the head portion 31 moves along the path of water sprayed from the cleansing nozzle 8 of the warm-water cleansing device 7 in cleansing of the anus. Since the anus is positioned at the end of the sprayed water, the head portion 31 can contact the vicinity of the anus. Thus, reliable wiping is realized.

Moreover, the length of the exposed portion of the nozzle is merely detected by the nozzle position detection unit 6a, and therefore, the structure of the sensor etc. for detection can be simplified.

Note that even for the warm-water cleansing device 7 having the function of adjusting a water spray area in addition to the function of adjusting the sprayed water pressure, at least one water spray path may be determined, and the control unit 5 may move the head portion 31 along such a path. Thus, the present disclosure can be also used for the warm-water cleansing device 7 having such functions.

### Second Embodiment

FIG. 7 is a block diagram of a functional configuration of a buttock wiping device 1 of a second embodiment of the present disclosure. FIG. 7 is different from the first embodiment in that an anus position estimation unit 6b is used instead of a nozzle position detection unit 6a. Differences from the first embodiment will be mainly described below.

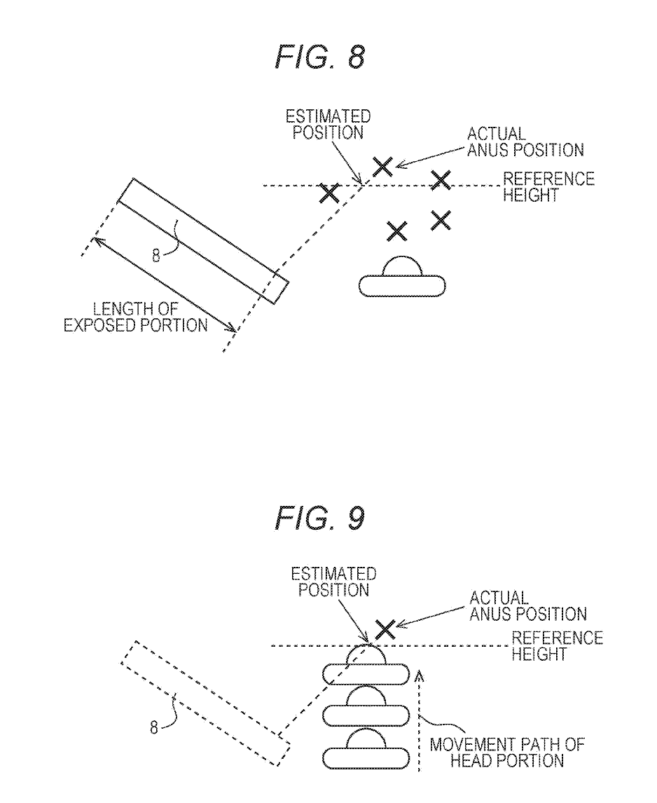

The anus position estimation unit 6b is configured to estimate an anus position from the length of an exposed portion of a cleansing nozzle 8. FIG. 8 is a view of the method for estimating the anus position. As illustrated in FIG. 8, in a case where water is sprayed with the cleansing nozzle 8 being stopped at a location according to a user's preference, an actual anus position is somewhere at the end of the sprayed water. Meanwhile, there is an individual difference in the height of the anus. Even when water is sprayed from the cleansing nozzle 8 at the same position, the actual anus position varies. For this reason, in the second embodiment, the anus position estimation unit 6b performs detection using the average height of the anus position as a reference height and using an intersection between a water spray direction and the reference height as an estimated position. The anus position estimation unit 6b at least needs to include a first sensor (not shown) configured to detect the length of the exposed portion of the cleansing nozzle 8. For example, a potentiometer can be used as the first sensor, but the present disclosure is not limited to such a sensor. With the length of the exposed portion, the intersection between the reference position and the water spray direction can be obtained by calculation.

Note that the estimated position can be obtained by calculation as described above, and therefore, the anus position estimation unit 6b may detect, using the first sensor, the length of the exposed portion and a control unit 5 may calculate the estimated position. In this case, the control unit 5 for calculating the estimated position functions as the anus position estimation unit 6b. In the second embodiment, the anus position is estimated using the length of the exposed portion of the cleansing nozzle 8 and the reference height.

Although the intersection between the estimated path of sprayed water and the reference average height of the anus position is taken as the estimated position, such an intersection varies, as described in the first embodiment, according to a sprayed water pressure in the case of a warm-water cleansing device 7 having the function of adjusting the sprayed water pressure. However, when the sprayed water pressure is determined, the estimated path is also determined. Thus, even in the warm-water cleansing device 7 having the function of adjusting the sprayed water pressure, the aspect of the second embodiment can be used.

Moreover, even in the warm-water cleansing device 7 having the function of adjusting a water spray area, at least one intersection can be obtained by determination of at least one path of sprayed water. Thus, even in the warm-water cleansing device 7 having the function of adjusting the water spray area, the aspect of the second embodiment can be used.

FIG. 9 is a view of a movement path when a head portion 31 moves toward the estimated position. As illustrated in FIG. 9, when the head portion 31 moves toward the estimated position, the head portion 31 might reach a position different from the actual anus position. However, the anus is actually present at the periphery of the estimated position, and therefore, moisture etc. at the periphery of the anus can be wiped when the control unit 5 controls a wiping arm drive unit 3 such that the head portion 31 moves back and forth, right to left, and up and down at the estimated position.

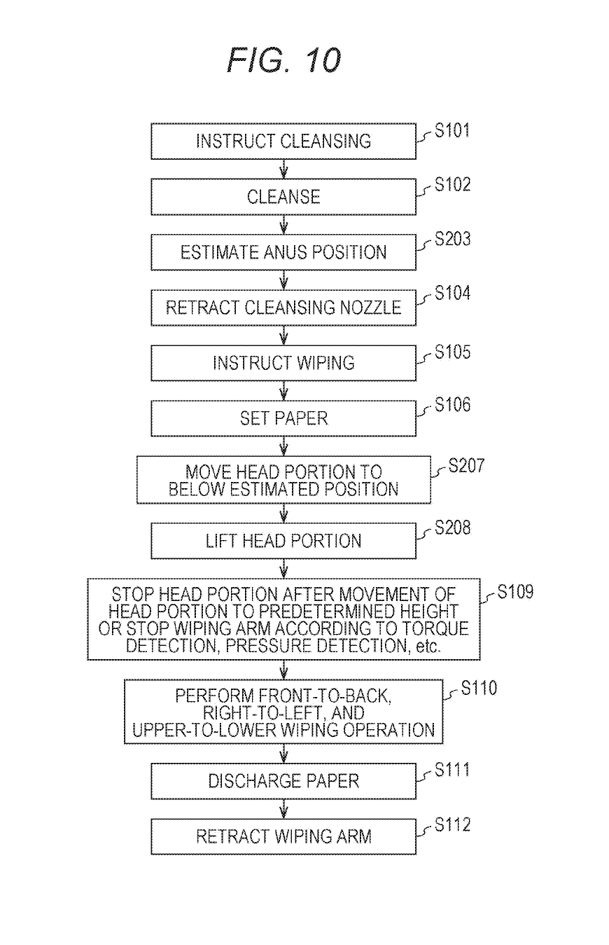

FIG. 10 is a flowchart of operation of the warm-water cleansing device 7 and the buttock wiping device 1 in the second embodiment. In FIG. 10, the same reference numerals as those of FIG. 6 of the first embodiment are used to represent similar operation, and description thereof will not be repeated. After cleansing, the anus position estimation unit 6b calculates the estimated position, thereby estimating the anus position (S203). Note that as described above, the control unit 5 may calculate the estimated position.

After paper has been set, the control unit 5 controls the wiping arm drive unit 3 to move the head portion 31 to below the estimated position (S207). Next, the control unit 5 controls the wiping arm drive unit 3 to lift the head portion 31 (S208). In this manner, the head portion 31 moves in the movement path as illustrated in FIG. 9.

Thereafter, the control unit 5 moves, as in the first embodiment, the head portion 31 back and forth, right to left, and up and down to wipe the periphery of the anus, followed by paper discharging and retracting.

As described above, according to the second embodiment, the anus position is estimated, and the control unit 5 controls a movement path of a wiping arm 2 such that the head portion 31 reaches the estimated position. With this structure, the anus position can be estimated according to the individual difference for movement of the head portion 31, and therefore, more reliable wiping is realized as compared to a typical method in which a head portion moves to an anus position assumed in a single uniform way. In the first embodiment, when the head portion 31 is moved, the head portion 31 needs to move along the water spray path. For this reason, the accuracy of control of the wiping arm drive unit 3 needs to be high. However, in the second embodiment, the head portion 31 is merely lifted from below the estimated position, and therefore, control of the wiping arm drive unit 3 is more facilitated as compared to the first embodiment.

Moreover, the length of the exposed portion of the nozzle is, as in the first embodiment, merely detected by the anus position estimation unit 6b, and therefore, the structure of the sensor etc. for detection can be simplified.

### Third Embodiment

FIG. 11 is a block diagram of a functional configuration of a buttock wiping device 1 of a third embodiment of the present disclosure. FIG. 11 is different from the first embodiment in that an anus position detection unit 6c is used instead of a nozzle position detection unit 6a. Differences from the first embodiment will be mainly described below.

The anus position detection unit 6c is a sensor for directly detecting an actual anus position, and includes a first sensor (not shown) configured to detect the length of an exposed portion of a cleansing nozzle 8 and a second sensor 6d attached to a tip end of the cleansing nozzle 8 to detect a distance to the anus position. A distance sensor using, e.g., laser or an ultrasonic wave can be used as the second sensor 6d, but the present disclosure is not limited to such a sensor.

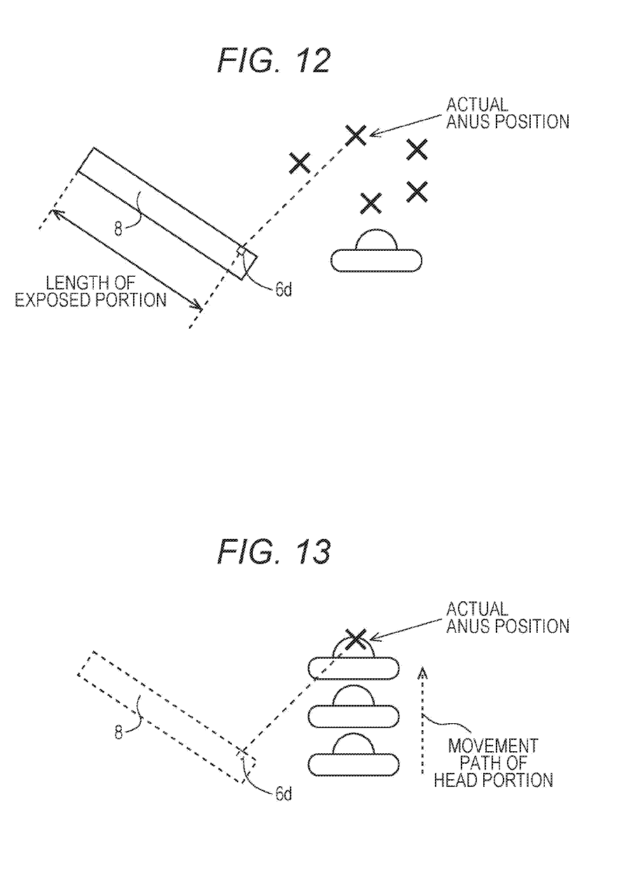

FIG. 12 is a view of the method for detecting the anus position. As illustrated in FIG. 12, the second sensor 6d is attached to the vicinity of a water spray port, and is able to perform, e.g., laser irradiation in the same direction as a spray angle. Thus, the distance to the anus as detected by the second sensor 6d is substantially equal to a distance to the actual anus position. The first sensor detects the length of the exposed portion of the cleansing nozzle 8, and the second sensor detects the distance from the tip end to the anus. In this manner, the actual anus position can be calculated. Such calculation may be made by the anus position detection unit 6c, or may be made by a control unit 5. In a case where the control unit 5 obtains, by calculation, the anus position, it can be said that the control unit 5 functions as the anus position detection unit 6c.

FIG. 13 is a view of a movement path when a head portion 31 moves toward the detected anus position. In the third embodiment, the anus position can be substantially accurately detected, and therefore, the head portion 31 can come into contact with the anus when the head portion 31 is moved and lifted from below the detected anus position.

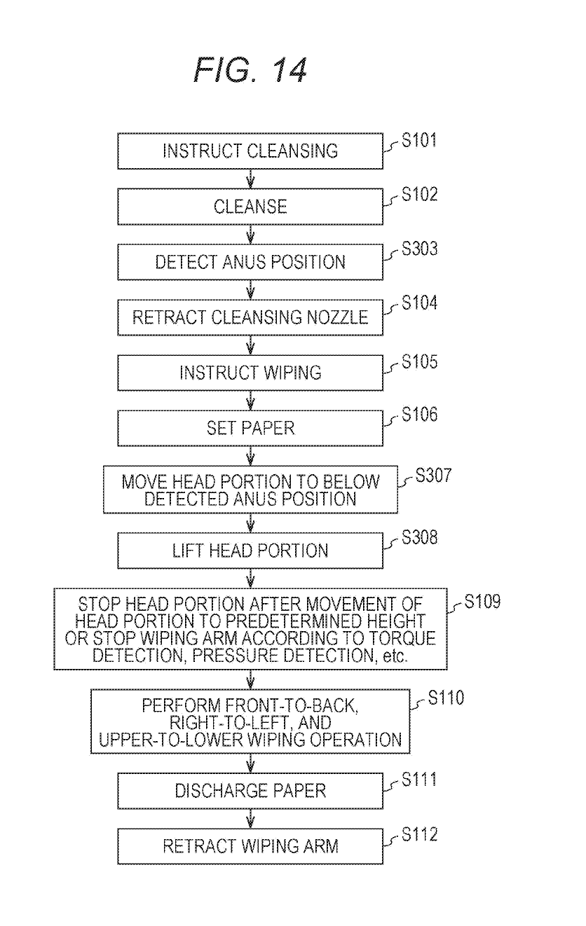

FIG. 14 is a flowchart of operation of a warm-water cleansing device 7 and the buttock wiping device 1 in the third embodiment. In FIG. 14, the same reference numerals as those of FIG. 6 of the first embodiment are used to represent similar operation, and description thereof will not be repeated. After cleansing, the anus position detection unit 6c calculates the anus position (See). Note that as described above, the control unit 5 may calculate the anus position.

After paper has been set, the control unit 5 controls a wiping arm drive unit 3 to move the head portion 31 to below the detected anus position (S307). Next, the control unit 5 controls the wiping arm drive unit 3 to lift the head portion 31 (S308). In this manner, the head portion 31 moves in the movement path as illustrated in FIG. 13.

Thereafter, the control unit 5 moves, as in the first embodiment, the head portion 31 back and forth, right to left, and up and down to wipe the periphery of anus, followed by paper discharging and retracting.

As described above, according to the third embodiment, the anus position is detected, and the control unit 5 controls a movement path of a wiping arm 2 such that the head portion 31 reaches the anus position. With this structure, the head portion 31 can be moved to an accurate anus position, leading to reliable wiping. In the first embodiment, when the head portion 31 is moved, the head portion 31 needs to move along the water spray path. For this reason, the accuracy of control of the wiping arm drive unit 3 needs to be high. However, in the third embodiment, the head portion 31 is merely lifted from below the anus position, and therefore, control of the wiping arm drive unit 3 is more facilitated as compared to the first embodiment.

Note that in the above-described embodiments, it is configured such that the head portion 31 moves to the anus position, but it may be configured such that the head portion 31 moves to a vagina position instead of the anus position. That is, the present disclosure can be also used in a case where wiping is automatically performed after the vagina has been cleansed using a bide function of the warm-water cleansing device 7.

In the case of the first embodiment, the nozzle position in cleansing of the vagina may be detected, and the control unit 5 of the buttock wiping device 1 may control the wiping arm 2 such that the head portion 31 moves from the detected nozzle position along the water spray path.

In the case of the second embodiment, the anus position estimation unit 6b may estimate the vagina position in cleansing of the vagina on the same principle as that for estimation of the anus position, and the control unit 5 of the buttock wiping device 1 may control the wiping arm 2 such that the head portion 31 moves to the estimated vagina position.

In the case of the third embodiment, the anus position detection unit 6c may detect the vagina position in cleansing of the vagina on the same principle as that for detection of the anus position, and the control unit 5 of the buttock wiping device 1 may control the wiping arm 2 such that the head portion 31 moves to the detected vagina position.

Thus, according to the present disclosure, wiping of the vagina can be properly performed in addition to wiping of the anus. When the anus and the vagina are collectively referred to as a “private area,” it can be said that the present disclosure relates to a buttock wiping device for wiping the private area, the buttock wiping device including the nozzle position detection unit 6a, a private area position estimation unit 6b instead of the anus position estimation unit 6b, and a private area position detection unit 6c instead of the anus position detection unit 6c. In this case, the present disclosure can be understood with all terms “anus” described above being replaced with the “private area.” Note that not only the anus but also the vagina is undeniably part of the buttocks, and therefore, the title “buttock wiping device” is used. However, it is appreciated that the buttocks are not limited to the anus, but include the vagina.

Note that in the first embodiment, the head portion 31 moves along the water spray path, but a movement destination point can be taken as an estimated private area position. Thus, regarding the first embodiment, it can be said that the control unit 5 controls the movement path of the wiping arm 2 such that the head portion 31 moves to the estimated private area position.

Moreover, in the second embodiment, it can be literally said that the private area position is estimated and the control unit 5 controls the movement path of the wiping arm 2 such that the head portion 31 moves to the estimated private area position.

Further, in the third embodiment, the private area position is detected.

However, the private area position is, in fact, merely predictively detected by the anus position detection unit 6c. Thus, in the third embodiment, it can be also said that the movement destination point of the head portion 31 is the estimated private area position. Consequently, regarding the third embodiment, it can be also said that the control unit 5 controls the movement path of the wiping arm 2 such that the head portion 31 moves to the estimated private area position.

As described above, the first to third embodiments have such a common concept that the control unit controls the movement path of the wiping arm such that the head portion moves to the estimated private area position.

The present disclosure has been described above in detail. However, such description has been merely an example of the present disclosure in every respect, and is not intended to limit the scope of the present disclosure. Needless to say, various modifications and changes can be made without departing from the scope of the present disclosure. The constituent features of the present disclosure in the present specification are regarded as independent features. Embodiments made by combination of the constituent features in any combination methods are included in the present disclosure.

The present disclosure relates to a buttock wiping device, and is industrially applicable.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A buttock wiping device comprising:
a wiping arm including a head portion;
a wiping arm drive unit configured to move the wiping arm; and
a control unit configured to control operation of the wiping arm drive unit,
wherein the control unit controls a movement path of the wiping arm such that the head portion moves to an estimated private area position.

2. A buttock wiping device comprising:
a wiping arm including a head portion;
a wiping arm drive unit configured to move the wiping arm; and
a control unit configured to control operation of the wiping arm drive unit,
wherein the control unit controls a movement path of the wiping arm such that the head portion moves along a path of water sprayed from a cleansing nozzle of a warm-water cleansing device in cleansing of a private area.

3. The buttock wiping device according to claim 2, further comprising:
a nozzle position detection unit configured to detect a position of the cleansing nozzle in cleansing of the private area,
wherein the control unit controls the movement path of the wiping arm such that the head portion moves along the water path based on the position of the cleansing nozzle detected h the nozzle position detection unit.

4. A buttock wiping device comprising:
a wiping arm including a head portion;
a wiping arm drive unit configured to move the wiping arm; and
a control unit configured to control operation of the wiping arm drive unit,
wherein a private area position is estimated, and the control unit controls a movement path of the wiping arm such that the head portion reaches the estimated position.

5. The buttock wiping device according to claim 4, further comprising:
a private area position estimation unit configured to estimate the private area position,
wherein the control unit controls the movement path of the wiping arm such that the head portion reaches the position estimated by the private area position estimation unit.

6. A buttock wiping device comprising:
a wiping arm including a head portion;
a wiping arm drive unit configured to move the wiping arm; and
a control unit configured to control operation of the wiping arm drive unit,
wherein the buttock wiping device further includes a private area position detection unit configured to detect a private area position, and
the control unit controls a movement path of the wiping arm such that the head portion reaches the private area position detected by the private area position detection unit.
